(19) United States
(12) Patent Application Publication
(10) Pub. No.: US 2023/0148796 A1
(43) Pub. Date: May 18, 2023

(54) METHOD FOR ADJUSTING THE GRIND SIZE OF A GRINDER, AND GRIND SIZE ADJUSTMENT ASSEMBLY OF A GRINDER

(71) Applicant: Melitta Professional Coffee Solutions GmbH & Co. KG, Minden (DE)

(72) Inventors: Kai HALLMANN, Minden (DE); Armin HENSEL, Rahden (DE); Bernd BUCHHOLZ, Rahden (DE)

(73) Assignee: Melitta Professional Coffee Solutions GmbH & Co. KG, Minden (DE)

(21) Appl. No.: 17/917,053

(22) PCT Filed: Apr. 1, 2021
(86) PCT No.: PCT/EP2021/058645

§ 371 Date: Oct. 5, 2022

(30) Foreign Application Priority Data
Apr. 6, 2020 (DE) 10 2020 109 528.7

(51) Int. Cl. A47J 42/18; A47J 42/16; G05B 15/02

(52) U.S. Cl. CPC A47J 42/18; A47J 42/16; G05B 15/02

(57) ABSTRACT

A grind size adjustment assembly, in particular a telemetric grind size adjustment assembly, has at least one grinder (2) for grinding coffee beans and a grind size adjustment device of the at least one grinder. The grind size adjustment assembly also has at least one remote control unit, which adjusts a grind size of the at least one grinder in operative connection with the grind size adjustment device of the at least one grinder.

### CROSS REFERENCE TO RELATED APPLICATIONS

This application is the National Stage of PCT/EP2021/058645 filed on Apr. 1, 2021, which claims priority under 35 U.S.C. § 119 of German Application No. 10 2020 109 528.7 filed on Apr. 6, 2020, the disclosure of which is incorporated by reference. The international application under PCT article 21(2) was not published in English.

### BACKGROUND OF THE INVENTION

The invention relates to a method for adjusting the grind size of a grinder for coffee beans. The invention also relates to a grind size adjustment assembly of a grinder.

Grinders for coffee beans are usually disc grinders or cone grinders. Both types of grinders consist of two grinding discs, where one grinding disc is fixed and the other is driven. To set a grind size in such grinders, for example, the distance between the two grinding tools is adjusted manually or by means of an electric adjustment device.

The invention therefore has the object of improving a grind size adjustment assembly of a grinder of a coffee mill.

### SUMMARY OF THE INVENTION

The invention solves this problem by a method for adjusting the grind size of a grinder and by a grind size adjustment assembly.

A method according to the invention for adjusting the grind size of at least one grinder for grinding coffee beans is characterized in that a grind size adjustment of the at least one grinder is carried out by means of a remote control unit arranged locally separate from the at least one grinder via a transmission link. It is also advantageously possible to set the grind size by means of telemetric remote access by the remote control unit in order to record current measured values of the grind size adjustment device.

The method can be carried out by means of a grind size adjustment assembly comprising the grinder and its grind size adjustment device. Furthermore, it further comprises the remote control unit.

A particular advantage is that a central setting of individual or several grinders to desired (e.g. identical) grind sizes and thus comparable product settings for achieving defined quality standards of several coffee machines (for example, for so-called chain customers) is made possible by setting the grinders by means of the remote control unit.

The at least one grinder may also be a grinder of a coffee grinder of a coffee machine or a stand-alone coffee machine.

### BRIEF DESCRIPTION OF THE DRAWINGS

In the following, the invention is described in more detail by means of exemplary embodiments with reference to the drawings, wherein:

FIG. 1: shows a schematic view of a grind size adjustment assembly according to the invention showing a front view in section of a principle of a grinder for grinding coffee beans; and

FIG. 2: shows a schematic view of the grind size adjustment assembly according to the invention with several coffee machines.

### DETAILED DESCRIPTION OF THE EMBODIMENTS

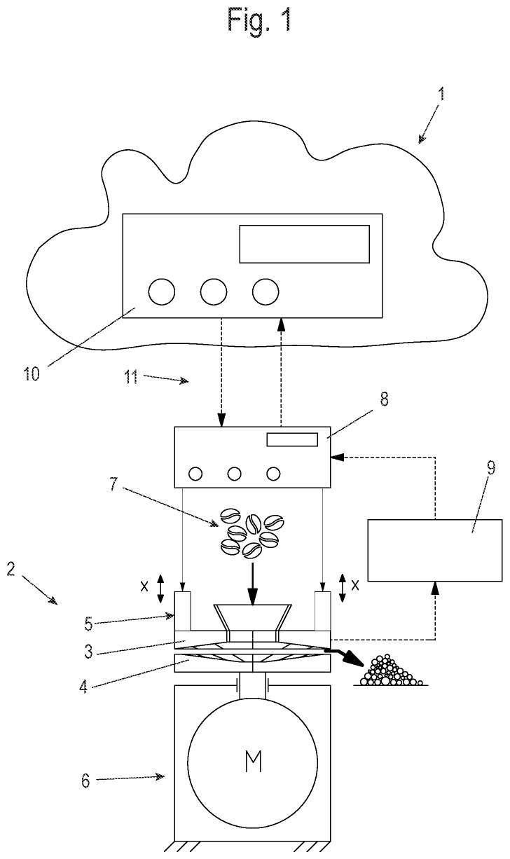

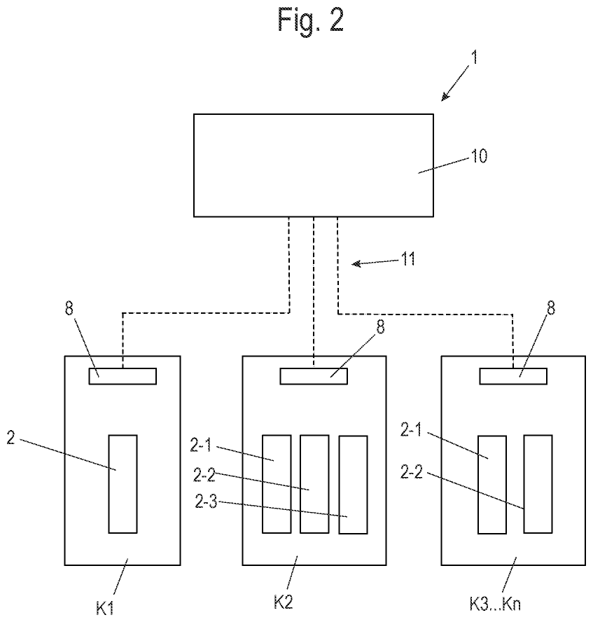

FIG. 1 shows a schematic view of a grind size adjustment assembly 1 according to the invention with a front view in section of a principle of a grinder 2 for grinding coffee beans 7. FIG. 2 shows a schematic view of the grind size adjustment assembly 1 according to the invention with a plurality of coffee machines K1, K2, K3, Kn.

In this exemplary embodiment, the grind size adjustment assembly 1 comprises at least one grinder 2 of a coffee grinder or coffee machine K1, K2, K3, Kn and a remote control unit 10. The grind size adjustment assembly 1 may also comprise several coffee grinders, coffee machines, each having at least one grinder 2. This is illustrated in FIG. 2.

Here, the grinder 2 comprises a first grinding disc 3 and a second grinding disc 4 and a drive unit 6. Here, the second grinding disc 4 is driven by the drive unit 6, with the first grinding disc 3 being stationary. However, both grinding discs 3, 4 or the first grinding disc 3 can also be driven.

The grinder 2 further comprises at least one grind size adjustment device 5. The grind size adjustment device 5 effects an adjustment of a grind size of the grinding mechanism. For this purpose, the grind size adjustment device 5 may act on the first grinding disc 3 and change an adjustment of a distance between the first grinding disc 3 and the second grinding disc 4. In another embodiment, a force acting on the grinding disc 3, 4 to be adjusted can also be changed to adjust the grind size. Other embodiments are also possible, but will not be considered further here. The grind size adjustment device 5 can also act on the second rotatable grinding disc 4 or on both grinding discs 3, 4.

The grind size adjustment device 5 can be driven, for example, electromotively by a stepper motor or servomotor controlled by a control unit 8. The control unit 8 also controls an electric drive of the drive unit 6.

Here, the remote control unit 10 communicates with the control unit 8 and with the grind size adjustment device 5 connected thereto. The grind size adjustment device 5 may also have its own control unit (not shown).

The remote control unit 10 is coupled to the control unit 8 via a transmission link 11. The transmission link 11 can be wired or wireless, e.g., radio, infrared, ultrasound, Internet, WLAN, LAN, etc. It is also conceivable that the remote control unit 10 is a smartphone.

The grinder 2 can also have a sensor device 9, which determines a current setting value of the grind size adjustment device 5 and transmits it to the control unit 8, which in turn can also transmit this value to the remote control unit 10. This enables remote measurement, i.e. telemetric measurement, of the respective current setting value of the grind size adjustment device 5 of the grinder 2 belonging to a coffee machine K1, K2, K3, Kn. The value determined in this way can be used for further, different purposes, e.g. statistics, overview, regulations, etc.

In this way, telemetric access is provided for the remote control unit 10. The term “telemetric” access is to be understood here as meaning that the remote control unit 10 sends data for setting the grind size adjustment device 5 to the control unit 8 of the grinder 2 via the transmission link 11. In addition, data, for example measured values of the settings of the grind size setting device 5 can also be transmitted to the remote control unit 10 via the transmission link.

FIG. 2 shows a grind size adjustment assembly 1 with three coffee machines K1, K2, K3. The reference sign Kn is intended to indicate that further coffee machines Kn can also be assigned to the grind size adjustment assembly 1.

Coffee machine K1 has one grinder 2, whereas coffee machine K2 includes three grinders 2-1, 2-2, 2-3. Coffee machine K3 includes two grinders 2-1, 2-2. Of course, more grinders 2 than shown can also be assigned to the respective coffee machine K1, K2, K3. Each coffee machine K1, K2, K3 has a control unit 8 here.

This enables a central setting of individual or several grinders 2, 2-1,2-2, 2-3 to desired (e.g. identical) grind sizes and thus comparable product settings for achieving defined quality standards of several coffee machines K1, K2, K3, Kn (for example with so-called chain customers) by controlling the grinders 2, 2-1,2-2, 2-3 via the telemetric access by means of the remote control unit 10.

The grind size adjustment assembly 1 may also comprise a so-called stand-alone coffee grinder with a grinder 2. In this case, the associated control unit 8 may be part of the grinder 2.

### LIST OF REFERENCE SIGNS

1 Grind size setting arrangement

2, 2-1, 2-2, 2-3 Grinder

3, 4 Grinding disc

5 Grind size adjustment device

6 Drive unit

7 Coffee bean

8 Control unit

9 Sensor device

10 Remote control unit

11 Transmission link

K1, K2, K3, Kn Coffee machine

1. A method for adjusting the grind size of at least one grinder for grinding coffee beans, wherein a grind size adjustment of the at least one grinder is carried out by means of a remote control unit arranged locally separate from the at least one grinder via a transmission link, the grind size adjustment of the at least one grinder is performed by means of a telemetric remote access by the remote control unit, wherein the grinder has a control unit and a sensor device and wherein the method comprises:
determining with the sensor device a current setting value of the grind size adjustment device,
transmitting the current setting value from the sensor device to the control unit of the grinder,
transmitting the current setting value from the control unit of the grinder to the remote control unit, and
sending data for setting the grind size adjustment device via the transmission link from the remote control unit to the control unit of the grinder.

2. (canceled).

3. A grind size adjustment assembly (1) comprising at least one grinder for grinding coffee beans, a grind size adjustment device of the at least one grinder, and a remote control unit which is in communication connection via a transmission link with a control unit of the grind size adjustment device for adjusting a grind size of the at least one grinder wherein the grinder has a sensor device which is configured to determine a current setting value of the grind size adjustment device and transmit the current setting value to the control unit, which in turn is designed to transmit the current setting value also to the remote control unit, and wherein the remote control unit is designed to transmit data for setting the grind size adjustment device via the transmission link to the control unit of the grinder.

4. The grind size adjustment assembly according to claim 3, wherein the at least one grinder is a grinder of a coffee grinder of a coffee.

5. The grind size adjustment assembly according to claim 3, wherein the at least one grinder is a grinder of a stand-alone coffee grinder.
